(19) United States
(12) Patent Application Publication
(10) Pub. No.: US 2023/0038757 A1
(43) Pub. Date: Feb. 9, 2023

(54) POWER CONVERTING APPARATUS AND REFRIGERATION CYCLE APPARATUS

(71) Applicant: Mitsubishi Electric Corporation, Tokyo (JP)

(72) Inventors: Koichi ARISAWA, Tokyo (JP); Takaaki TAKAHARA, Tokyo (JP); Hajime TOYODA, Tokyo (JP); Satoshi MURAKAMI, Tokyo (JP); Keisuke UEMURA, Tokyo (JP); Takahiko KOBAYASHI, Tokyo (JP)

(21) Appl. No.: 17/790,379

(22) PCT Filed: Jan. 21, 2020
(86) PCT No.: PCT/JP2020/001948

§ 371 Date: Jun. 30, 2022

(51) Int. Cl. H02M 7/23; H02M 1/00; H02M 1/32

(52) U.S. Cl. CPC H02M 7/23; H02M 1/0009; H02M 1/32

(57) ABSTRACT

A power converting apparatus that converts alternating-current power from an alternating-current power supply into direct-current power and outputs the direct-current power to a direct-current load includes at least two switching circuits connected in parallel with the direct-current load; a coupling reactor that includes at least three connection terminals with two of the at least three connection terminals connected to an alternating-current terminal of one switching circuit different from two switching circuits among the at least two switching circuits; and a control unit that performs, at least once in a half period of the alternating-current power supply, a simple switching control that short-circuits the coupling reactor to the alternating-current power supply through the two switching circuits.

### CROSS REFERENCE TO RELATED APPLICATION

This application is a U.S. National Stage Application of International Patent No. PCT/JP2020/001948 filed on Jan. 21, 2020, the disclosure of which is incorporated herein by reference.

### TECHNICAL FIELD

The present invention relates to a power converting apparatus for converting an alternating-current power into a direct-current power and to a refrigeration cycle apparatus.

### BACKGROUND

A conventional power converting apparatus controls a power factor of alternating-current power as well as providing a boosted output voltage higher in amplitude than an alternating-current voltage during rectification of the alternating-current power into a direct-current power. Such a power converting apparatus generally includes parallel-connected switching circuits made up of reactors, and a switching element, etc. for, for example, obtaining higher output power or reducing input current ripples. Each of the parallel-connected switching circuits needs to have the reactor in order to allow a leveled current to pass through the switching circuit. Unfortunately, providing the reactor for each switching circuit results in an increased volume of the reactors and thus leads to an increased volume of the power converting apparatus.

To address this problem, Patent Literature 1 discloses a technique of using, in a power converting apparatus, a coupling reactor defined by a plurality of reactors integrated together. Specifically, the power converting apparatus described in Patent Literature 1 includes a noise filter and a rectifier circuit disposed at a stage following an alternating-current power supply, and two parallel-connected switching circuits disposed between the rectifier circuit and an output capacitor. Each of the switching circuits includes a reactor, a switching element, and a diode.

### PATENT LITERATURE

Patent Literature 1: Japanese Patent Application Laid-open No. 2014-78577

The power converting apparatus described in Patent Literature 1 continuously switches the two switching circuits at a higher frequency of over 10 kHz than a frequency of the alternating-current power supply. For this reason, the power converting apparatus described in Patent Literature 1 suffers from problems of a decrease in circuit efficiency due to an increase in switching loss caused upon the switching of the switching elements on and off, and an increase in high-frequency copper/iron loss at the excitation of the reactors at the higher frequency.

### SUMMARY

The present invention has been made in view of the above, and an object of the prevent invention is to obtain a power converting apparatus capable of converting power with high efficiency, reducing losses at switching elements and a reactor due to a high frequency.

To solve the above problem and achieve the object, the present invention provides a power converting apparatus for converting an alternating-current power supplied from an alternating-current power supply into a direct-current power and outputs the direct-current power to a direct-current load. The power converting apparatus comprising: two or more switching circuits connected in parallel with the direct-current load; a coupling reactor including three or more connection terminals, two of the at least three connection terminals being each connected to an alternating-current terminal of a corresponding one of two switching circuits among the two or more switching circuits; and a control unit performing, at least once in a half period of the alternating-current power supply, a simple switching control allowing the two switching circuits to short-circuit the coupling reactor to the alternating-current power supply.

The power converting apparatus according to the present invention is capable of converting the power conversion with high efficiency, reducing the losses at the switching elements and the reactor due to the high frequency.

### BRIEF DESCRIPTION OF DRAWINGS

FIG. 1 illustrates an example configuration of a power converting apparatus according to a first embodiment.

FIG. 2 illustrates an example configuration of a coupling reactor of the power converting apparatus according to the first embodiment.

FIG. 3 illustrates current paths when only a switching element 3b of the converting apparatus according to the first embodiment is in an on state in the case of the positive polarity of the alternating-current power supply.

FIG. 4 illustrates current paths when only a switching element 3d of the power converting apparatus according to the first embodiment is in an on state in the case of the positive polarity of the alternating-current power supply.

FIG. 5 illustrates current paths when the switching elements 3b and 3d of the power converting apparatus according to the first embodiment are in off states in the case of the positive polarity of the alternating-current power supply.

FIG. 6 illustrates current paths when the switching elements 3b and 3d of the power converting apparatus according to the first embodiment are in the on states in the case of the positive polarity of the alternating-current power supply.

FIG. 7 illustrates current paths when only a switching element 3a of the power converting apparatus according to the first embodiment is in an on state in the case of the negative polarity of the alternating-current power supply.

FIG. 8 illustrates current paths when only a switching element 3c of the power converting apparatus according to the first embodiment is in an on state in the case of the negative polarity of the alternating-current power supply.

FIG. 9 illustrates current paths when the switching elements 3a and 3c of the power converting apparatus according to the first embodiment are in off states in the case of the negative polarity of the alternating-current power supply.

FIG. 10 illustrates current paths when the switching elements 3a and 3c of the power converting apparatus according to the first embodiment are in the on states in the case of the negative polarity of the alternating-current power supply.

FIG. 11 illustrates a relation between an increase/decrease in the absolute value of the alternating current and the on/off state of each of the switching elements of the switching circuits in the power converting apparatus according to the first embodiment when the absolute value of the alternating-current voltage is smaller than one-half of the direct-current voltage.

FIG. 12 illustrates a relation between the increase/decrease in the absolute value of the alternating current and the on/off state of each of the switching elements of the switching circuits in the power converting apparatus according to the first embodiment when the absolute value of the alternating-current voltage is greater than the one-half of the direct-current voltage.

FIG. 13 illustrates a first example configuration of the power converting apparatus according to the first embodiment that controls the alternating current and the direct-current voltage through a simple switching control.

FIG. 14 illustrates a second example configuration of the power converting apparatus according to the first embodiment that controls the alternating current and the direct-current voltage through the simple switching control.

FIG. 15 illustrates an example of a simple switching control in which the power converting apparatus according to the first embodiment performs switching twice in the half period of the alternating-current power supply.

FIG. 16 illustrates an example configuration in which a direct-current load connected to the power converting apparatus according to the first embodiment is an inverter.

FIG. 17 illustrates a first modification to the power converting apparatus according to the first embodiment.

FIG. 18 illustrates a second modification to the power converting apparatus according to the first embodiment.

FIG. 19 illustrates a third modification to the power converting apparatus according to the first embodiment.

FIG. 20 is a flowchart illustrating an operation of performing the simple switching control by a control unit of the power converting apparatus according to the first embodiment.

FIG. 21 illustrates an example of a hardware configuration that implements the control unit of the power converting apparatus according to the first embodiment.

FIG. 22 illustrates a first example configuration of a power converting apparatus according to a second embodiment.

FIG. 23 illustrates a second example configuration of the power converting apparatus according to the second embodiment.

FIG. 24 illustrates an example configuration of a refrigeration cycle apparatus according to a third embodiment.

### DETAILED DESCRIPTION

With reference to the drawings, a detailed description is hereinafter provided of power converting apparatuses and a refrigeration cycle apparatus according to embodiments of the present invention. It is to be noted that these embodiments are not restrictive of the present invention.

### First Embodiment

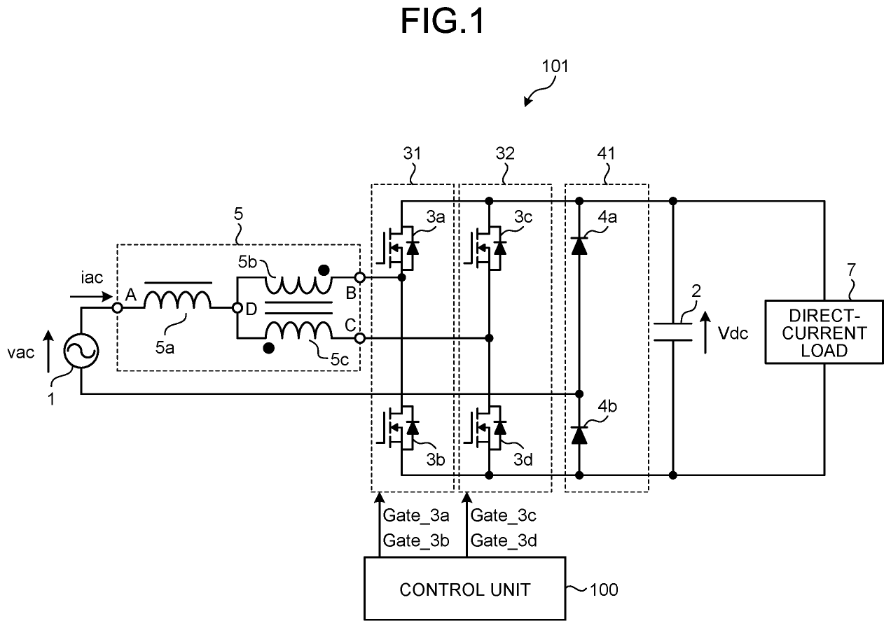

FIG. 1 illustrates an example configuration of a power converting apparatus 101 according to the first embodiment of the present invention. The power converting apparatus 101 converts an alternating-current power from an alternating-current power supply 1 into a direct-current power and then outputs the direct-current power to a direct-current load 7 connected in parallel with a smoothing capacitor 2. The direct-current load 7 is, for example, a light-emitting diode (LED) or a battery, but may be an inverter including an output terminal connected to an alternating-current load such as a rotating machine or a direct current (DC) to DC converter connected to a direct-current load such as a LED or a battery. The alternating-current power supply 1 may be defined by a direct-current power supply outputting direct-current power and an inverter converting the direct-current power into the alternating-current power.

The power converting apparatus 101 includes the smoothing capacitor 2, a coupling reactor 5, switching circuits 31 and 32, a rectifier circuit 41, and a control unit 100. The coupling reactor 5 includes three terminals A to C serving as connection terminals. Among the three terminals A to C, the terminal A is connected to one end of the alternating-current power supply 1, the terminal B is connected to an alternating-current terminal of the switching circuit 31, and the terminal C is connected to an alternating-current terminal of the switching circuit 32.

The switching circuit 31 is connected in parallel with the direct-current load 7. The switching circuit 31 includes switching elements 3a and 3b connected in series. A connection point between the switching elements 3a and 3b is the alternating-current terminal connected to the terminal B of the coupling reactor 5. The switching circuit 32 is connected in parallel with the direct-current load 7. The switching circuit 32 includes switching elements 3c and 3d connected in series. A connection point between the switching elements 3c and 3d is the alternating-current terminal connected to the terminal C of the coupling reactor 5. The power converting apparatus 101 may include three or more switching circuits. This means that the power converting apparatus 101 includes two or more switching circuits connected in parallel with the direct-current load 7. Each of the switching circuits 31 and 32 may include three or more switching elements. This means that each of the switching circuits 31 and 32 includes two or more switching elements. Each of the switching elements 3a to 3d is a switching element including a parasitic diode that is an antiparallel diode. Each of the switching elements 3a to 3d is, for example, a metal-oxide-semiconductor field-effect transistor (MOSFET) that is not limiting. Each of the switching elements 3a to 3d may include an antiparallel diode separate from an element that performs a switching operation.

The rectifier circuit 41 includes rectifying elements 4a and 4b. A connection point between the rectifying elements 4a and 4b is an alternating-current terminal connected to an opposite end of the alternating-current power supply 1. The smoothing capacitor 2 smooths voltage from the rectifier circuit 41. The control unit 100 generates control signals Gate_3a to Gate_3d for the switching elements 3a to 3d to control the operations of the switching circuits 31 and 32. Specifically, the control unit 100 performs, at least once in a half period of the alternating-current power supply 1, a simple switching control that allows the two switching circuits 31 and 32 to short-circuit the coupling reactor 5 to the alternating-current power supply 1. In performing the simple switching control, the control unit 100 determines the number of times the two switching circuits 31 and 32 perform switching and ON times of the switching circuits 31 and 32 and assigns the determined number of times and the determined ON times to the two switching circuits 31 and 32.

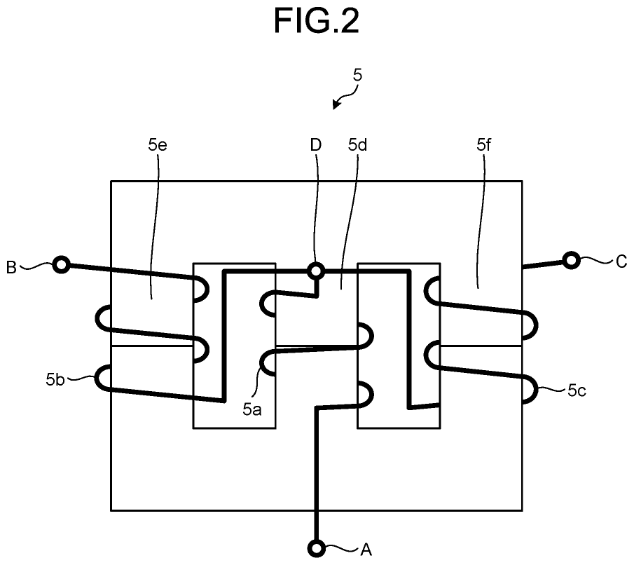

A description is provided here of a configuration of the coupling reactor 5. FIG. 2 illustrates an example configuration of the coupling reactor 5 of the power converting apparatus 101 according to the first embodiment. The coupling reactor 5 includes three cores 5d to 5f and three windings 5a, 5b, 5c that wind on the cores 5d to 5f, respectively. The winding 5a winds on the core 5d, the winding 5b winds on the core 5e, and the winding 5c winds around the core 5f. Each winding has one end connected to a terminal D. The above-mentioned terminal A connects an opposite end of the winding 5a to the one end of the alternating-current power supply 1. The above-mentioned terminal B connects an opposite end of the winding 5b to the alternating-current terminal of the switching circuit 31. The above-mentioned terminal C connects an opposite end of the winding 5c to the alternating-current terminal of the switching circuit 32.

The core 5e of the coupling reactor 5 is a first wound part on which the winding 5b winds. The winding 5b is a first winding connected to one of the two terminals B and C that are the connection terminals. The core 5f of the coupling reactor 5 is a second wound part on which the winding 5c winds. The winding 5c is a second winding connected to the other of the terminals B and C that are the two connection terminals. The windings 5b and 5c of the coupling reactor 5, which are the first winding and the second winding, are AC-coupled to each other. The windings 5b and 5c are AC-coupled as illustrated in FIG. 1. For this reason, the cores 5e, 5f, on which the windings 5b, 5c wind, have magnetic fluxes induced in directions that correspond to the operations of the switching circuits 31 and 32. The core 5d, on which the winding 5a winds, has a magnetic flux induced in a direction that corresponds to the polarity of the alternating-current power supply 1.

The coupling reactor 5 may have the windings 5b and 5c that each wind on both the cores 5e and 5f for enhanced coupling between the windings 5b and 5c. Any or every one of the cores 5d to 5f of the coupling reactor 5 may include a gap for improving saturation characteristics. The number of turns of each winding, the cross-sectional area of each core, etc. of the coupling reactor 5 may be changed in accordance with necessary inductance. For example, the coupling reactor 5 may have the winding 5a with the different turns from those of the windings 5b and 5c. The core 5d may have a cross-sectional area different from those of the cores 5e and 5f. The windings 5b and 5c may have the different turns. The cores 5e and 5f may have different cross-sectional areas. Without using the winding 5a, the coupling reactor 5 may use the terminal D as the terminal A. The coupling reactor 5 may include a connection terminal in addition to the terminals A to C. In other words, the coupling reactor 5 may include three or more connection terminals. Two of the three or more connection terminals of the coupling reactor 5 are each connected to an alternating-current terminal of the corresponding one of the two switching circuits 31 and 32 among the two or more switching circuits.

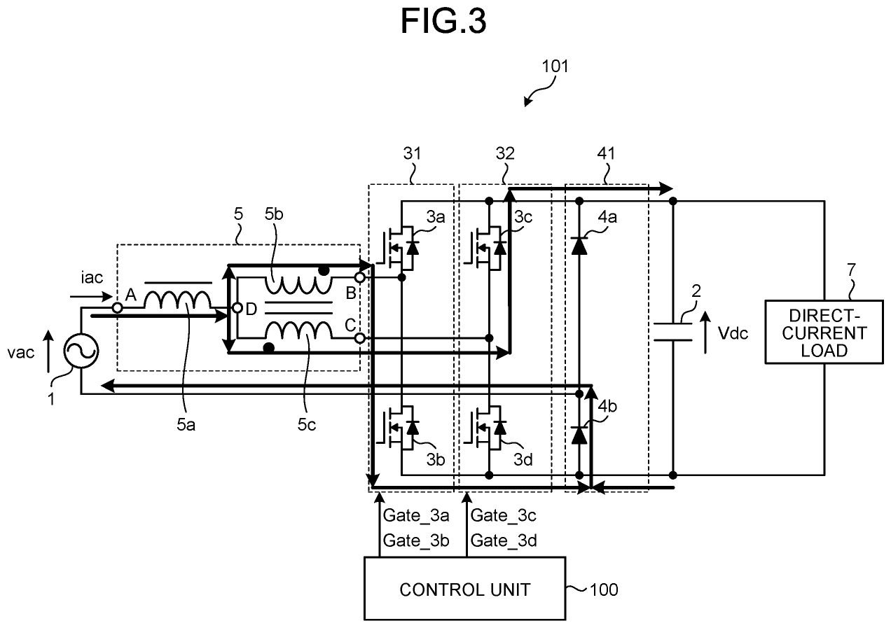

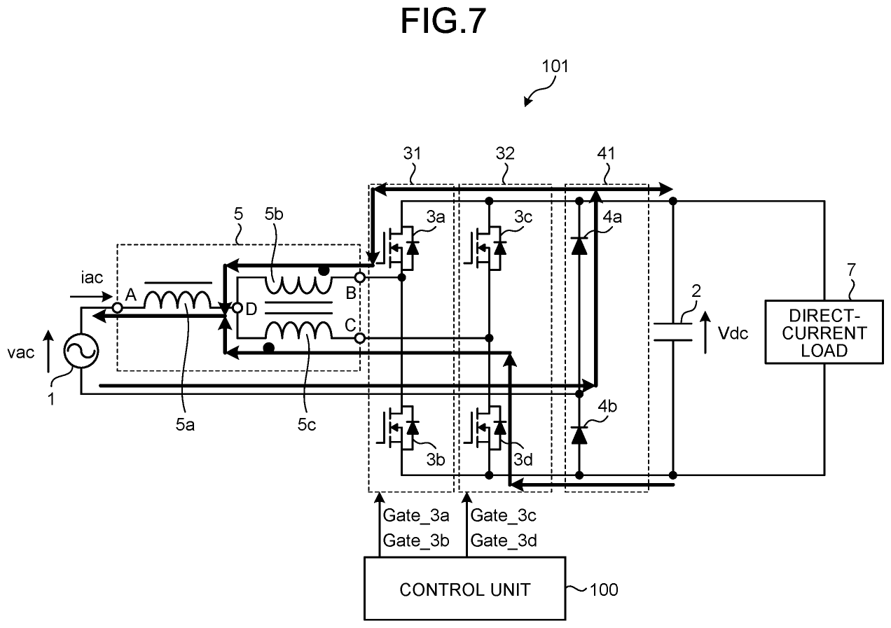

Next, a description is made as to operating modes of the power converting apparatus 101 in the case of the switching state of each switching element of the switching circuits 31 and 32. FIGS. 3 to 6 illustrate operating modes of the power converting apparatus 101 when the polarity of the alternating-current power supply 1 is positive. FIGS. 7 to 10 illustrate operating modes of the power converting apparatus 101 when the polarity of the alternating-current power supply 1 is negative.

When the polarity of the alternating-current power supply 1 is positive, the switching elements 3b and 3d serve to short-circuit the coupling reactor 5 to the alternating-current power supply 1. When the polarity of the alternating-current power supply 1 is positive, the power converting apparatus 101 has four operating modes in which: both the switching elements 3b and 3d are in on states; one of the switching elements 3b and 3d is in the on state; the other of the switching elements 3b and 3d is in the on state; and both the switching elements 3b and 3d are in off states. Voltages applied to the coupling reactor 5 by the switching circuits 31 and 32 are examined below. For the sake of simplicity, an on-state voltage of a semiconductor is not taken into consideration.

FIG. 3 illustrates current paths when only the switching element 3b of the power converting apparatus 101 according to the first embodiment is in an on state in the case of the positive polarity of the alternating-current power supply 1. As illustrated in FIG. 3, current flows from the winding 5a to the rectifying element 4b via a path extending through the winding 5b and the switching element 3b and a path extending through the winding 5c, the parasitic diode of the switching element 3c, and the smoothing capacitor 2. In this case, the voltage that the switching circuit 31 applies to the coupling reactor 5 is an alternating-current voltage vac of the alternating-current power supplied from the alternating-current power supply 1 to the power converting apparatus 101. The voltage that the switching circuit 32 applies to the coupling reactor 5 is vac−Vdc, i.e., the alternating-current voltage vac minus a direct-current voltage Vdc across the smoothing capacitor 2. The direct-current voltage Vdc is a direct-current voltage of the direct-current power output from the power converting apparatus 101. This means that a total voltage of vac+vac−Vdc=2vac−Vdc is applied to the coupling reactor 5. When the alternating-current voltage vac is smaller than one-half of the direct-current voltage Vdc, therefore, the total voltage is negative, and an absolute value |iac| of an alternating current of the alternating-current power supplied from the alternating-current power supply 1 to the power converting apparatus 101 decreases. When the alternating-current voltage vac is greater than the one-half of the direct-current voltage Vdc, the total voltage is positive, and the absolute value |iac| of the alternating current of the alternating-current power supplied from the alternating-current power supply 1 to the power converting apparatus 101 increases.

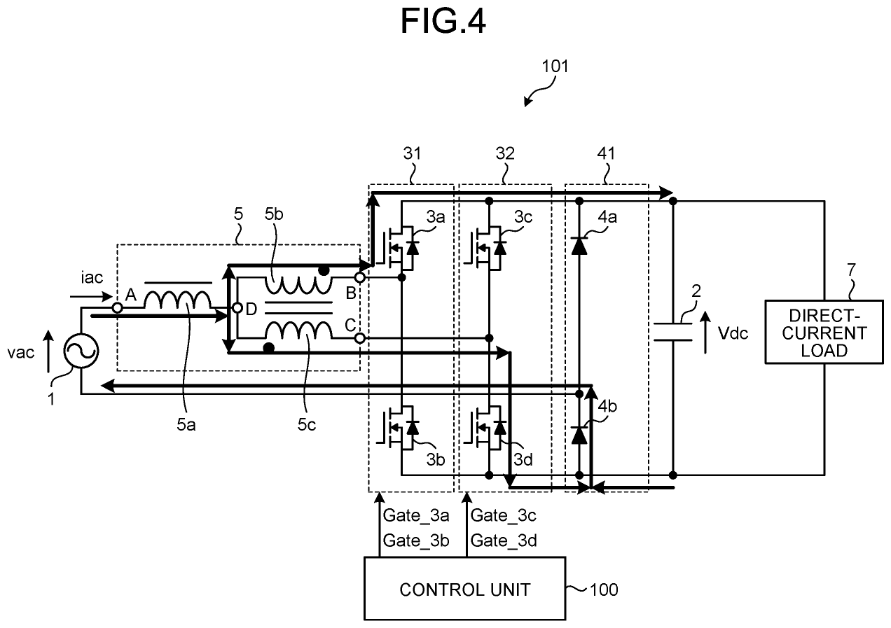

FIG. 4 illustrates current paths when only the switching element 3d of the power converting apparatus 101 according to the first embodiment is in an on state in the case of the positive polarity of the alternating-current power supply 1. As illustrated in FIG. 4, current flows from the winding 5a to the rectifying element 4b via a path extending through the winding 5b, the parasitic diode of the switching element 3a, and the smoothing capacitor 2 and a path extending through the winding 5c and the switching element 3d. In this case, the voltage that the switching circuit 31 applies to the coupling reactor 5 is vac−Vdc, i.e., the alternating-current voltage vac minus the direct-current voltage Vdc. The voltage that the switching circuit 32 applies to the coupling reactor 5 is the alternating-current voltage vac. This means that a total voltage of vac−Vdc+vac=2vac−Vdc is applied to the coupling reactor 5. When the alternating-current voltage vac is smaller than the one-half of the direct-current voltage Vdc, therefore, the total voltage is negative, and the absolute value |iac| of the alternating current decreases. When the alternating-current voltage vac is greater than the one-half of the direct-current voltage Vdc, the total voltage is positive, and the absolute value |iac| of the alternating current increases.

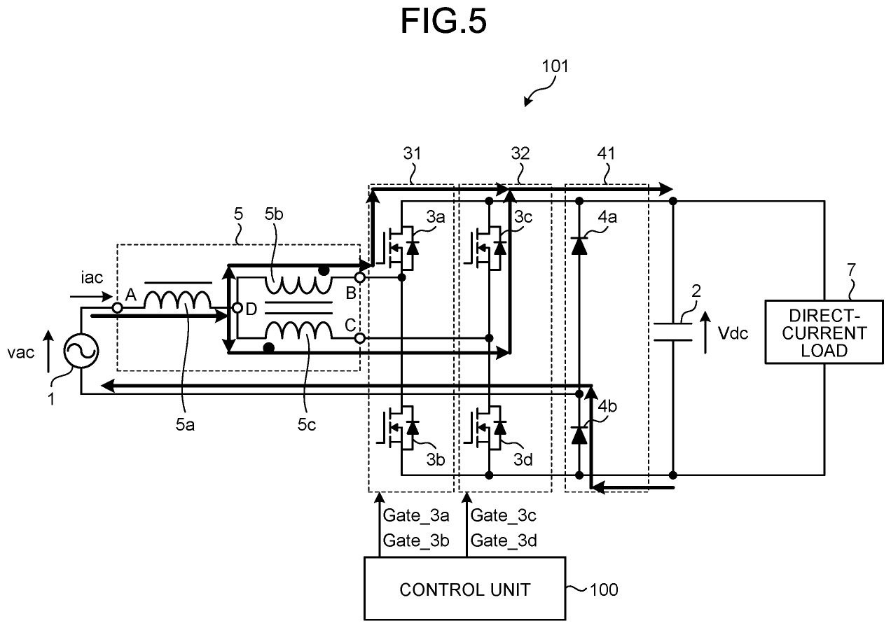

FIG. 5 illustrates current paths when the switching elements 3b and 3d of the power converting apparatus 101 according to the first embodiment are in off states in the case of the positive polarity of the alternating-current power supply 1. As illustrated in FIG. 5, current flows from the winding 5a to the rectifying element 4b via a path extending through the winding 5b, the parasitic diode of the switching element 3a, and the smoothing capacitor 2 and a path extending through the winding 5c, the parasitic diode of the switching element 3c, and the smoothing capacitor 2. In this case, the voltage that the switching circuit 31 applies to the coupling reactor 5 is vac−Vdc, i.e., the alternating-current voltage vac minus the direct-current voltage Vdc. The voltage that the switching circuit 32 applies to the coupling reactor 5 is vac−Vdc, i.e., the alternating-current voltage vac minus the direct-current voltage Vdc. This means that a total voltage of vac−Vdc+vac−Vdc=2(vac−Vdc) is applied to the coupling reactor 5. Since the power converting apparatus 101 according to the present embodiment is of a boost type, an absolute value |vac| of the alternating-current voltage is always smaller than the direct-current voltage Vdc. For this reason, the total voltage is always negative irrespective of phase of the alternating-current voltage vac, and the absolute value |iac| of the alternating current decreases.

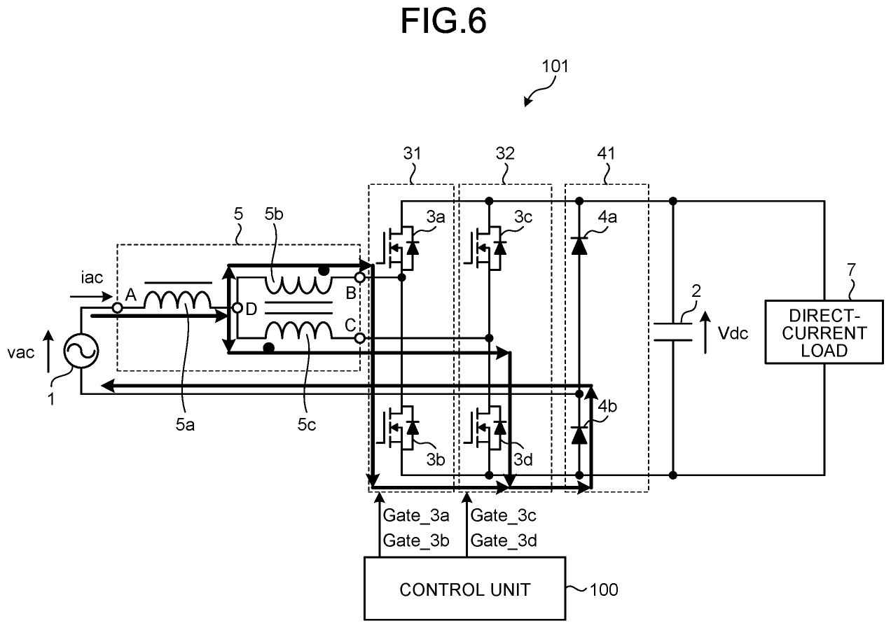

FIG. 6 illustrates current paths when the switching elements 3b and 3d of the power converting apparatus 101 according to the first embodiment are in the on states in the case of the positive polarity of the alternating-current power supply 1. As illustrated in FIG. 6, current flows from the winding 5a to the rectifying element 4b via a path extending through the winding 5b and the switching element 3b and a path extending through the winding 5c and the switching element 3d. In this case, the voltage that the switching circuit 31 applies to the coupling reactor 5 is the alternating-current voltage vac. The voltage that the switching circuit 32 applies to the coupling reactor 5 is the alternating-current voltage vac. This means that a total voltage of vac+vac=2vac is applied to the coupling reactor 5. Since the alternating-current voltage of 2vac is always positive, the absolute value |iac| of the alternating current increases.

When the polarity of the alternating-current power supply 1 is negative, the switching elements 3a and 3c serve to short-circuit the coupling reactor 5 to the alternating-current power supply 1 in the same manner as discussed above. When the polarity of the alternating-current power supply 1 is negative, the power converting apparatus 101 has four operating modes in which: both the switching elements 3a and 3c are in on states; one of the switching elements 3a and 3c is in the on state; the other of the switching elements 3a and 3c is in the on state; and both the switching elements 3a and 3c are in off states. Voltages applied to the coupling reactor 5 by the switching circuits 31 and 32 are examined below. For the sake of simplicity, an on-state voltage of a semiconductor is not taken into consideration.

FIG. 7 illustrates current paths when only the switching element 3a of the power converting apparatus 101 according to the first embodiment is in an on state in the case of the negative polarity of the alternating-current power supply 1. As illustrated in FIG. 7, current flows from the rectifying element 4a to the winding 5a via a path extending through the switching element 3a and the winding 5b and a path extending through the smoothing capacitor 2, the parasitic diode of the switching element 3d, and the winding 5c. In this case, the voltage that the switching circuit 31 applies to the coupling reactor 5 is an alternating-current voltage (−vac). The voltage that the switching circuit 32 applies to the coupling reactor 5 is −vac+Vdc, i.e., the alternating-current voltage (−vac) plus the direct-current voltage Vdc. This means that a total voltage of −vac−vac+Vdc=−2vac+Vdc is applied to the coupling reactor 5. When the absolute value |vac| of the alternating-current voltage is smaller than the one-half of the direct-current voltage Vdc, therefore, the total voltage is positive, and the absolute value |iac| of the alternating current decreases. When the absolute value |vac| of the alternating-current voltage is greater than the one-half of the direct-current voltage Vdc, the total voltage is negative, and the absolute value |iac| of the alternating current increases.

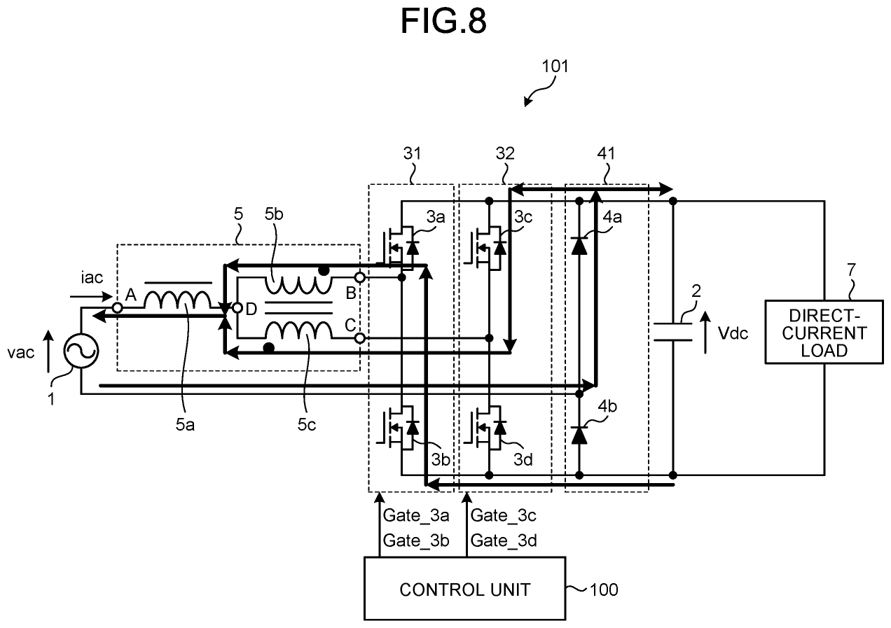

FIG. 8 illustrates current paths when only the switching element 3c of the power converting apparatus 101 according to the first embodiment is in an on state in the case of the negative polarity of the alternating-current power supply 1. As illustrated in FIG. 8, current flows from the rectifying element 4a to the winding 5a via a path extending through the smoothing capacitor 2, the parasitic diode of the switching element 3b, and the winding 5b and a path extending through the switching element 3c and the winding 5c. In this case, the voltage that the switching circuit 31 applies to the coupling reactor 5 is −vac+Vdc, i.e., the alternating-current voltage (−vac) plus the direct-current voltage Vdc. The voltage that the switching circuit 32 applies to the coupling reactor 5 is the alternating-current voltage (−vac). This means that a total voltage of −vac+Vdc−vac=−2vac+Vdc is applied to the coupling reactor 5. When the absolute value |vac| of the alternating-current voltage is smaller than the one-half of the direct-current voltage Vdc, therefore, the total voltage is positive, and the absolute value |iac| of the alternating current decreases. When the absolute value |vac| of the alternating-current voltage is greater than the one-half of the direct-current voltage Vdc, the total voltage is negative, and the absolute value |iac| of the alternating current increases.

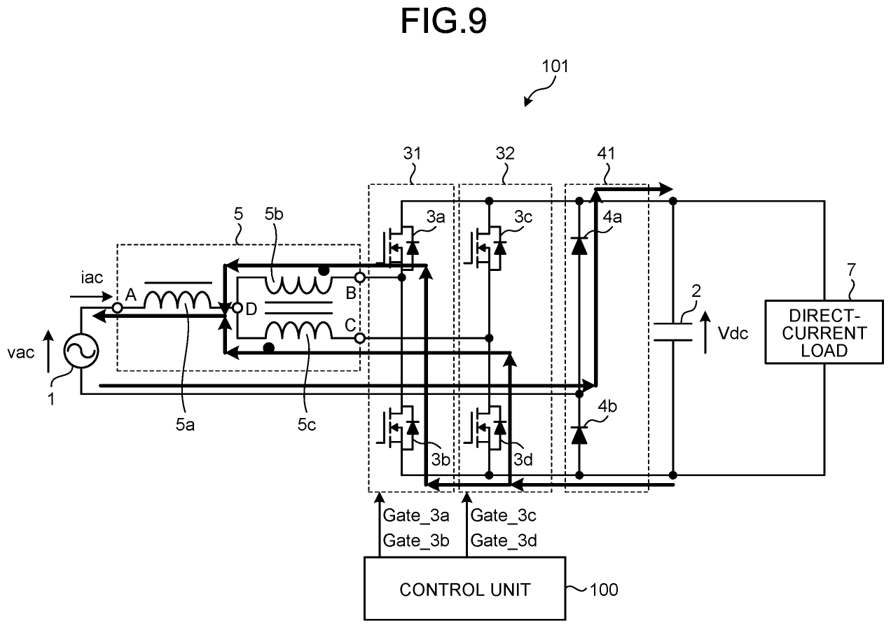

FIG. 9 illustrates current paths when the switching elements 3a and 3c of the power converting apparatus 101 according to the first embodiment are in off states in the case of the negative polarity of the alternating-current power supply 1. As illustrated in FIG. 9, current flows from the rectifying element 4a to the winding 5a via a path extending through the smoothing capacitor 2, the parasitic diode of the switching element 3b, and the winding 5b and a path extending through the smoothing capacitor 2, the parasitic diode of the switching element 3d, and the winding 5c. In this case, the voltage that the switching circuit 31 applies to the coupling reactor 5 is −vac+Vdc, i.e., the alternating-current voltage (−vac) plus the direct-current voltage Vdc. The voltage that the switching circuit 32 applies to the coupling reactor 5 is −vac+Vdc, i.e., the alternating-current voltage (−vac) plus the direct-current voltage Vdc. This means that a total voltage of 2(−vac+Vdc) is applied to the coupling reactor 5. Since the power converting apparatus 101 according to the present embodiment is of the boost type here, the absolute value |vac| of the alternating-current voltage is always smaller than the direct-current voltage Vdc. For this reason, the total voltage is always positive irrespective of the phase of the alternating-current voltage vac, and the absolute value |iac| of the alternating current decreases.

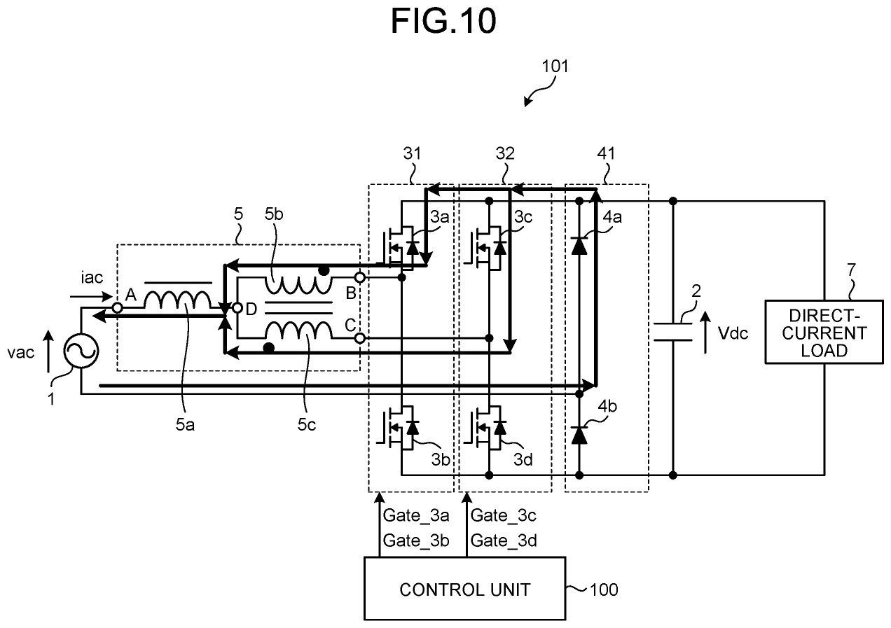

FIG. 10 illustrates current paths when the switching elements 3a and 3c of the power converting apparatus 101 according to the first embodiment are in the on states in the case of the negative polarity of the alternating-current power supply 1. As illustrated in FIG. 10, current flows from the rectifying element 4a to the winding 5a via a path extending through the switching element 3a and the winding 5b and a path extending through the switching element 3c and the winding 5c. In this case, the voltage that the switching circuit 31 applies to the coupling reactor 5 is the alternating-current voltage (−vac). The voltage that the switching circuit 32 applies to the coupling reactor 5 is the alternating-current voltage (−vac). This means that a total voltage of −vac−vac=−2vac is applied to the coupling reactor 5. Since the alternating-current voltage of (−2vac) is always negative, the absolute value |iac| of the alternating current increases.

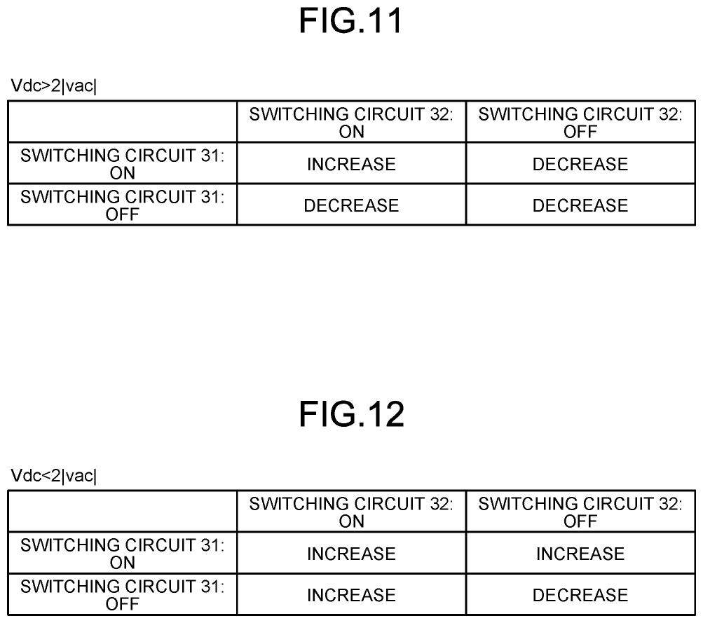

FIG. 11 illustrates a relation between an increase/decrease in the absolute value |iac| of the alternating current and the on/off state of each of the switching elements 3a to 3d of the switching circuits 31 and 32 in the power converting apparatus 101 according to the first embodiment when the absolute value |vac| of the alternating-current voltage is smaller than the one-half of the direct-current voltage Vdc. FIG. 12 illustrates a relation between the increase/decrease in the absolute value |iac| of the alternating current and the on/off state of each of the switching elements 3a to 3d of the switching circuits 31 and 32 in the power converting apparatus 101 according to the first embodiment when the absolute value |vac| of the alternating-current voltage is greater than the one-half of the direct-current voltage Vdc. It is to be noted that either of the relational expressions described in FIGS. 11 and 12 may include an equal sign.

In FIG. 11, the absolute value |iac| of the alternating current increases only when both of the switching circuits 31 and 32 having their switching elements in the on states short-circuit the coupling reactor 5 to the alternating-current power supply 1 as illustrated in FIG. 6 or 10. The other operating modes illustrated in FIG. 11 decrease the absolute value |iac| of the alternating current. When only one of the switching circuits 31 and 32 short-circuits the coupling reactor 5 to the alternating-current power supply 1 as illustrated in FIG. 3, 4, 7, or 8, the absolute value of the voltage to the coupling reactor 5 is smaller than when neither of the switching circuits 31 and 32 short-circuits the coupling reactor 5 to the alternating-current power supply 1 as illustrated in FIG. 5 or 9.

In FIG. 12, the absolute value |iac| of the alternating current decreases only when neither of the switching circuits 31 and 32 having their switching elements in the off states short-circuits the coupling reactor 5 to the alternating-current power supply 1 as illustrated in FIG. 5 or 9. The other operating modes illustrated in FIG. 12 increase the absolute value |iac| of the alternating current. When only one of the switching circuits 31 and 32 short-circuits the coupling reactor 5 to the alternating-current power supply 1 as illustrated in FIG. 3, 4, 7, or 8, the absolute value of the voltage to the coupling reactor 5 is smaller than when both of the switching circuits 31 and 32 short-circuit the coupling reactor 5 to the alternating-current power supply 1 as illustrated in FIG. 6 or 10.

In other words, the operating mode that lessens the absolute value of the voltage applied to the coupling reactor 5 is selected and executed under the control unit 100, such that the power converting apparatus 101 reduces the voltage applied to the coupling reactor 5, thereby providing advantageous effects such as reducing core losses and reduced copper losses that result from reduction in current ripple of the alternating current iac.

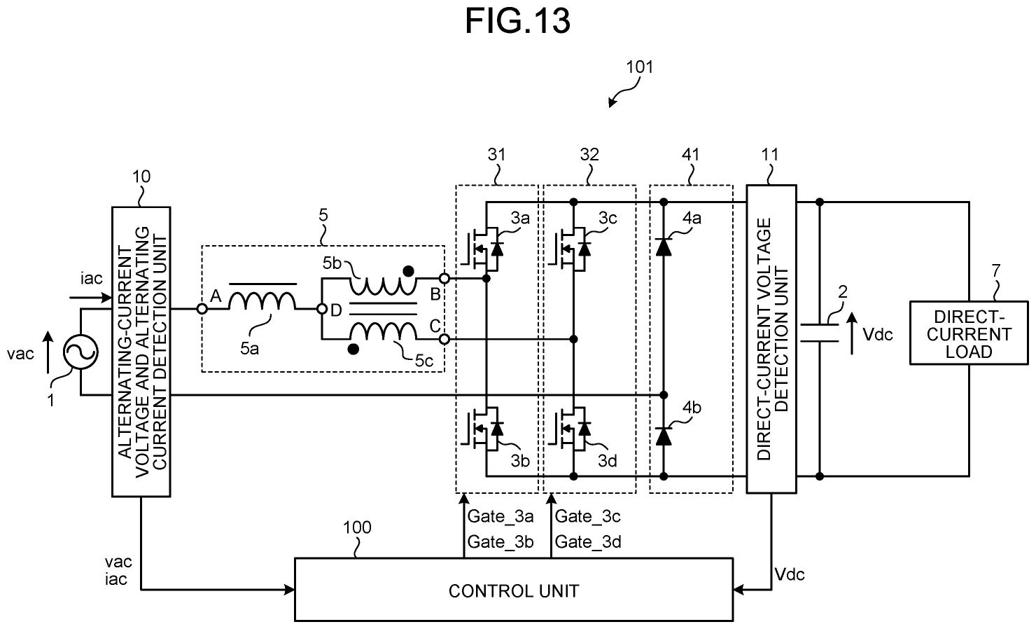

FIG. 13 illustrates a first example configuration of the power converting apparatus 101 according to the first embodiment that controls the alternating current iac and the direct-current voltage Vdc through the simple switching control. In addition to the configuration illustrated in FIG. 1, etc., this power converting apparatus 101 includes an alternating-current voltage and alternating current detection unit 10 and a direct-current voltage detection unit 11. The alternating-current voltage and alternating current detection unit 10 detects the alternating-current voltage vac and the alternating current iac of the alternating-current power that are supplied from the alternating-current power supply 1 to the power converting apparatus 101. The direct-current voltage detection unit 11 detects the direct-current voltage of the direct-current power output from the power converting apparatus 101 to the direct-current load 7. The control unit 100 obtains the alternating-current voltage vac and the alternating current iac as results of detection by the alternating-current voltage and alternating current detection unit 10 and the direct-current voltage Vdc as a result of detection by the direct-current voltage detection unit 11. On the basis of the obtained alternating-current voltage vac, the obtained alternating current iac, and the obtained direct-current voltage Vdc, the control unit 100 controls the two switching circuits 31 and 32. Specifically, the control unit 100 generates the control signals Gate_3a to Gate_3d for the switching elements 3a to 3d. The control unit 100 outputs the control signals Gate_3a and Gate_3b to the switching circuit 31 and the control signals Gate_3c and Gate_3d to the switching circuit 32. The control unit 100 may control the two switching circuits 31 and 32, that is to say, determine the number of times each of the switching circuits 31 and 32 performs switching and the ON time of each of the switching circuits 31 and 32, on the basis of any one of the detection results from the alternating-current voltage and alternating current detection unit 10 and the direct-current voltage detection unit 11.

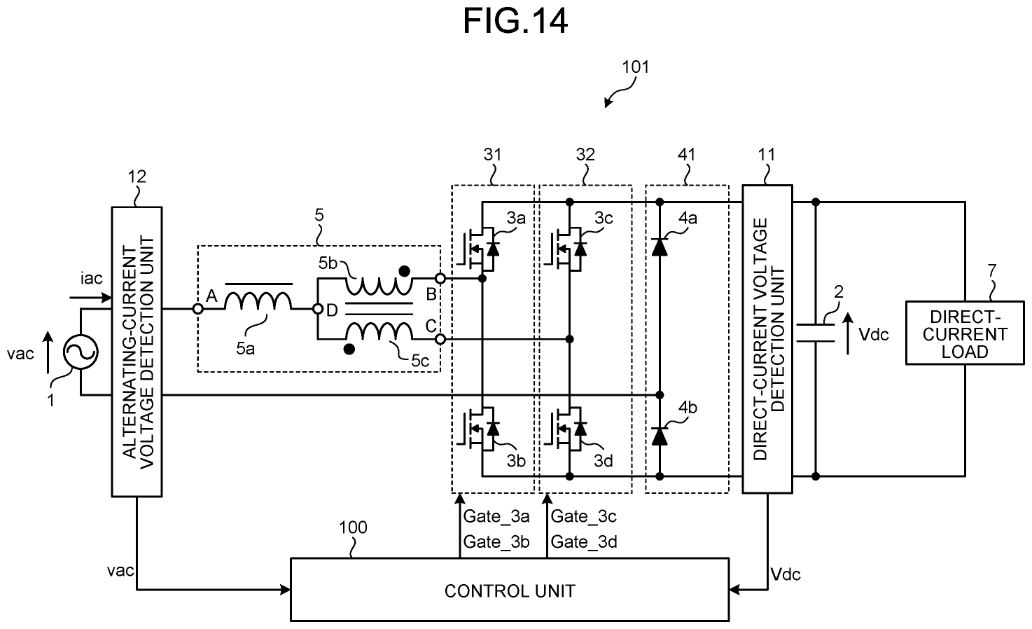

The power converting apparatus 101 need not use the alternating current iac of the alternating-current power supply 1. FIG. 14 illustrates a second example configuration of the power converting apparatus 101 according to the first embodiment that controls the alternating current iac and the direct-current voltage Vdc through the simple switching control. In addition to the configuration illustrated in FIG. 1, etc., this power converting apparatus 101 includes an alternating-current voltage detection unit 12 and the direct-current voltage detection unit 11. The alternating-current voltage detection unit 12 detects the alternating-current voltage vac of the alternating-current power supplied from the alternating-current power supply 1 to the power converting apparatus 101. The control unit 100 obtains the alternating-current voltage vac as a result of detection by the alternating-current voltage detection unit 12 and the direct-current voltage Vdc as a result of detection by the direct-current voltage detection unit 11. On the basis of the obtained alternating-current voltage vac and the obtained direct-current voltage Vdc, the control unit 100 controls the two switching circuits 31 and 32. Specifically, the control unit 100 generates the control signals Gate_3a to Gate_3d for the switching elements 3a to 3d. The control unit 100 outputs the control signals Gate_3a and Gate_3b to the switching circuit 31 and the control signals Gate_3c and Gate_3d to the switching circuit 32. The control unit 100 may control the two switching circuits 31 and 32, that is to say, determine the number of times each of the switching circuits 31 and 32 performs switching and the ON time of each of the switching circuits 31 and 32, on the basis of either the detection result from the alternating-current voltage detection unit 12 or the detection result from the direct-current voltage detection unit 11.

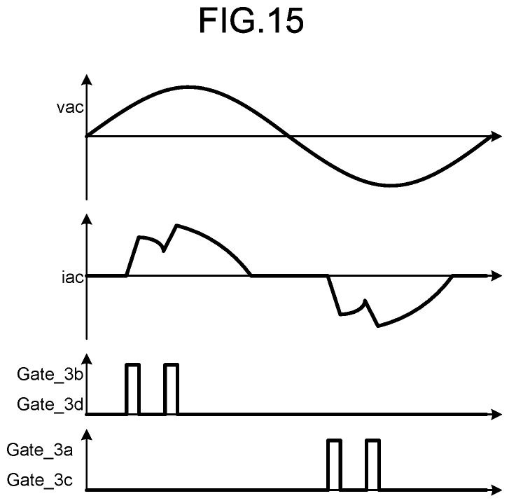

On the basis of the detection results from the alternating-current voltage and alternating current detection unit 10 and the direct-current voltage detection unit 11 illustrated in FIG. 13 or the detection results from the alternating-current voltage detection unit 12 and the direct-current voltage detection unit 11 illustrated in FIG. 14, the control unit 100 switches the switching circuit to operate in a half period of the alternating-current power supplied from the alternating-current power supply 1. FIG. 15 illustrates an example of a simple switching control in which the power converting apparatus 101 according to the first embodiment performs switching twice in the half period of the alternating-current power supply 1. During a positive half-wave of the alternating-current voltage vac, the control unit 100 of the power converting apparatus 101 simultaneously switches on or off the switching elements 3b and 3d that can increase the alternating current iac irrespective of whether which one of the alternating-current voltage |vac| and the direct-current voltage Vdc is larger or smaller than the other, as stated above. During a negative half-wave of the alternating-current voltage vac, the control unit 100 of the power converting apparatus 101 similarly simultaneously switches on or off the switching elements 3a and 3c that can increase the alternating current iac irrespective of whether which one of the alternating-current voltage |vac| and the direct-current voltage Vdc is larger or smaller than the other, as stated above. In the power converting apparatus 101, the alternating current |iac| increases in a period of time during which each switching element is in the on state, and decreases in a period of time during which each switching element is in the off state.

In the simple switching control, the control unit 100 switches on or off at least one switching element of one of the two switching circuits 31 and 32 or switches on or off at least one switching element of each of the switching circuits 31 and 32. For example, in cases where the windings and cores of the coupling reactor connected to the switching element 3a of the switching circuit 31 and the switching element 3c of the switching circuit 32 have different turns and different cross-sectional areas, etc., the power converting apparatus 101 can change an amount of change in the increase in the alternating current iac illustrated in FIG. 15 when one of the switching elements 3a and 3c is used. In cases where the windings and cores of the coupling reactor connected to the switching element 3b of the switching circuit 31 and the switching element 3d of the switching circuit 32 have different turns and different cross-sectional areas, etc., the power converting apparatus 101 can similarly change an amount of change in the increase in the alternating current iac illustrated in FIG. 15 when one of the switching elements 3b and 3d is used. In the simple switching control, the control unit 100 controls, for example, the alternating current iac and the direct-current voltage Vdc by controlling the number of times the switching of each switching element is to be performed, and the ON time of each switching element, etc.

The control unit 100 provides the simple switching control that performs the switching once or several times between twice and twenty times, for example, in the half period of the alternating-current power supply 1. With constraints such as a power factor and harmonics of the alternating-current power supply 1 imposed, the control unit 100 performs the simple switching control with the increased number of times the switching is to be performed, in which case the power converting apparatus 101 increases losses such as a switching loss caused upon switching of the switching elements on and off, and copper and iron loss caused in the coupling reactor 5. By performing the simple switching control with the increased number of times the switching is to be performed, however, the control unit 100 can improve the power factor, the harmonics, etc. In view of this, the control unit 100 desirably sets as small the number of times the switching is to be performed as possible to such an extent that the constraints are avoidable.

The control unit 100 can, by way of example, derive the number of times the switching is to be performed and the ON time for the simple switching control from internal arithmetic processing on the basis of, for example, the results of detection by the alternating-current voltage and alternating current detection unit 10, the direct-current voltage detection unit 11, the alternating-current voltage detection unit 12, etc. Alternately, the control unit 100 may predetermine and pre-store information including the number of times the switching is to be performed and the ON time in accordance with an operating condition and read out the pre-stored information on the basis of the detection results.

Specifically, when a value twice the absolute value |vac| of the alternating-current voltage detected by the alternating-current voltage and alternating current detection unit 10 or the alternating-current voltage detection unit 12 is greater than the direct-current voltage Vdc detected by the direct-current voltage detection unit 11, the control unit 100 allows one or both of the two switching circuits 31 and 32 to short-circuit the coupling reactor 5 to the alternating-current power supply 1. This enables the control unit 100 to increase the absolute value |iac| of the alternating current of the alternating-current power.

Moreover, the control unit 100 stops both of the two switching circuits 31 and 32 when the value twice the absolute value |vac| of the alternating-current voltage detected by the alternating-current voltage and alternating current detection unit 10 or the alternating-current voltage detection unit 12 is greater than the direct-current voltage Vdc detected by the direct-current voltage detection unit 11. This enables the control unit 100 to decrease the absolute value of the alternating current of the alternating-current power.

When the value twice the absolute value |vac| of the alternating-current voltage detected by the alternating-current voltage and alternating current detection unit 10 or the alternating-current voltage detection unit 12 is smaller than the direct-current voltage Vdc detected by the direct-current voltage detection unit 11, the control unit 100 allows both of the two switching circuits 31 and 32 to short-circuit the coupling reactor 5 to the alternating-current power supply 1. This enables the control unit 100 to increase the absolute value of the alternating current of the alternating-current power.

Moreover, the control unit 100 stops one or both of the two switching circuits 31 and 32 when the value twice the absolute value |vac| of the alternating-current voltage detected by the alternating-current voltage and alternating current detection unit 10 or the alternating-current voltage detection unit 12 is smaller than the direct-current voltage Vdc detected by the direct-current voltage detection unit 11. This enables the control unit 100 to decrease the absolute value of the alternating current of the alternating-current power.

It is to be noted here that the control unit 100 may determine the number of times the switching is to be performed and the ON time for the simple switching control on the basis of an operating state of the direct-current load 7. In that case, the power converting apparatus 101 includes a direct-current voltage and direct current detection unit that detects the direct-current voltage Vdc across and a direct current in the direct-current load 7. The power converting apparatus 101 can determine the number of times the switching is to be performed and the ON time, on the basis of the results of detection by the direct-current voltage and direct current detection unit.

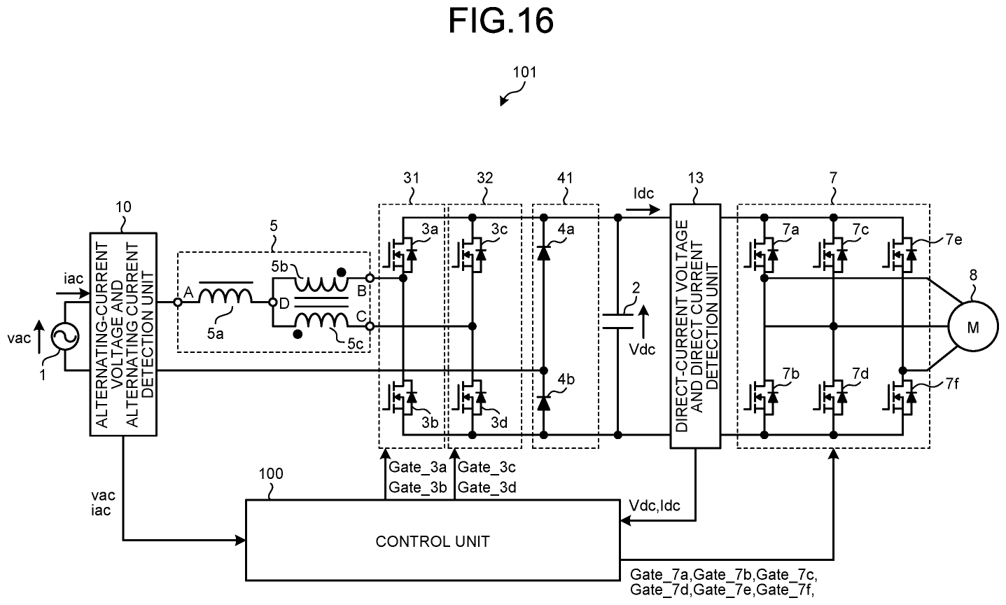

As illustrated in FIG. 16, the direct-current load 7 may be an inverter connected to a motor 8. FIG. 16 illustrates an example configuration in which the direct-current load 7 connected to the power converting apparatus 101 according to the first embodiment is the inverter. In this case, the power converting apparatus 101 includes a direct-current voltage and direct current detection unit 13 that detects the direct-current voltage Vdc and the direct current Idc of the direct-current power output from the power converting apparatus 101 to the direct-current load 7. On the basis of the detection results from the direct-current voltage and direct current detection unit 13, the control unit 100 determines the number of times each of the switching elements of the switching circuits 31 and 32 performs switching and the ON time of each of the switching elements of the switching circuits 31 and 32. The control unit 100 calculates an output frequency, output torque, an output voltage, an output current, and others of the inverter on the basis of the detection results from the direct-current voltage and direct current detection unit 13. On the basis of at least one of the output frequency, the output torque, the output voltage, and the output current of the inverter, the control unit 100 may determine the number of times each of the switching elements of the switching circuits 31 and 32 performs switching and the ON time of each of the switching elements of the switching circuits 31 and 32. In the configuration of the power converting apparatus 101 as in FIG. 16, the control unit 100 generates control signals Gate_7a to Gate_7f on the basis of the detection results from the direct-current voltage and direct current detection unit 13 and others to control operations of switching elements 7a to 7f of the inverter, which is direct-current load 7. The power converting apparatus 101 may use a detection result from a detection unit other than those illustrated in FIG. 16 to control the inverter.

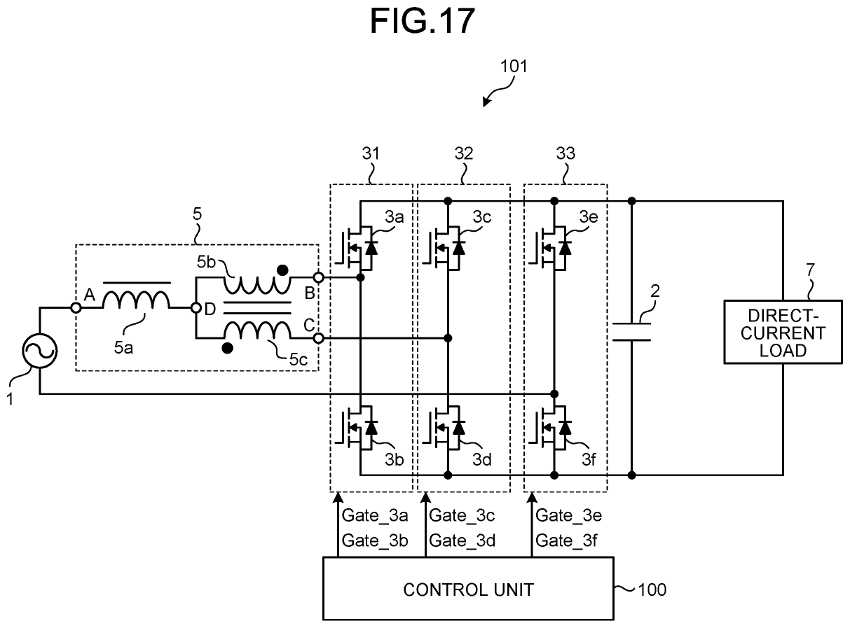

In the power converting apparatus 101, the rectifier circuit 41 that includes the two rectifying elements is replaceable with two switching elements. FIG. 17 illustrates a first modification to the power converting apparatus 101 according to the first embodiment. The power converting apparatus 101 illustrated in FIG. 17 is the power converting apparatus 101 illustrated in FIG. 1, etc. with the rectifier circuit 41 omitted and a switching circuit 33 added. The switching circuit 33 is connected in parallel with the direct-current load 7. The switching circuit 33 includes switching elements 3e and 3f connected in series. As with the switching circuits 31 and 32, the switching circuit 33 may include three or more switching elements. This means that the switching circuit 33 includes two or more switching elements.

In the power converting apparatus 101 having the configuration illustrated in FIG. 17, the control unit 100 is capable of performing synchronous rectification that switches on the switching element 3e or 3f in accordance with voltage polarity or current polarity of the alternating-current power supply 1. In other words, on the basis of the polarity of the alternating-current voltage or the alternating current of the alternating-current power supplied from the alternating-current power supply 1, the control unit 100 switches on at least one switching element of the switching circuits 31 to 33 to perform the synchronous rectification. The control unit 100 generates control signals Gate_3e and Gate_3f for the switching elements 3e and 3f to control the switching elements 3e and 3f such that the switching elements are switched on and off.

The control unit 100 of the power converting apparatus 101 configured as illustrated in FIG. 1 may perform the synchronous rectification that switches on the switching elements having current flowing through the parasitic diode thereof without short-circuiting the coupling reactor 5 to the alternating-current power supply 1 in the operating modes illustrated in FIGS. 3 to 10. The switching element does not short-circuit the coupling reactor 5 to the alternating-current power supply 1, during which period of time the control unit 100 performs the synchronous rectification that switches on the switching element not short-circuiting the coupling reactor 5 to the alternating-current power supply 1.

With the synchronous rectification, the control unit 100 can reduce loss caused at the switching element when a conduction loss of the switching element is smaller than a conduction loss caused by a forward voltage drop of the parasitic diode.

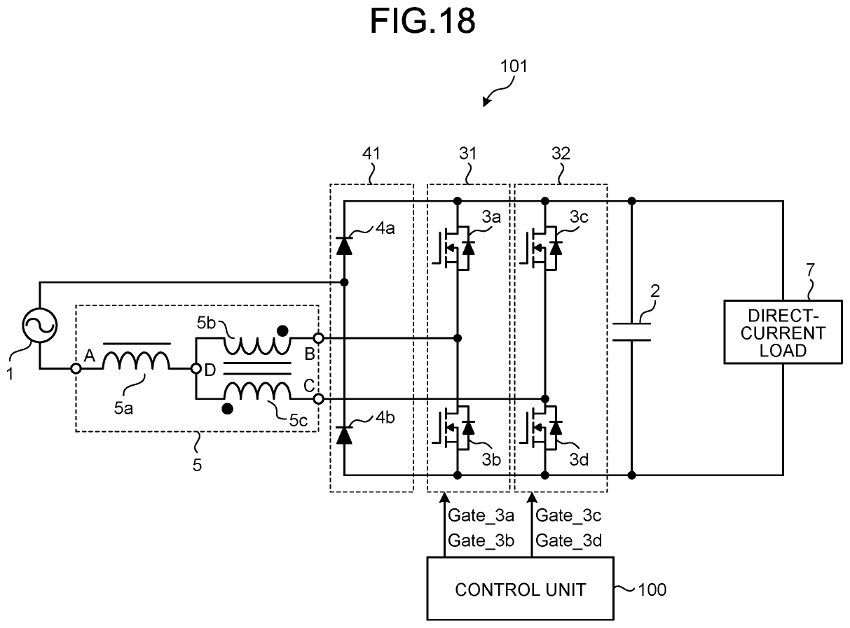

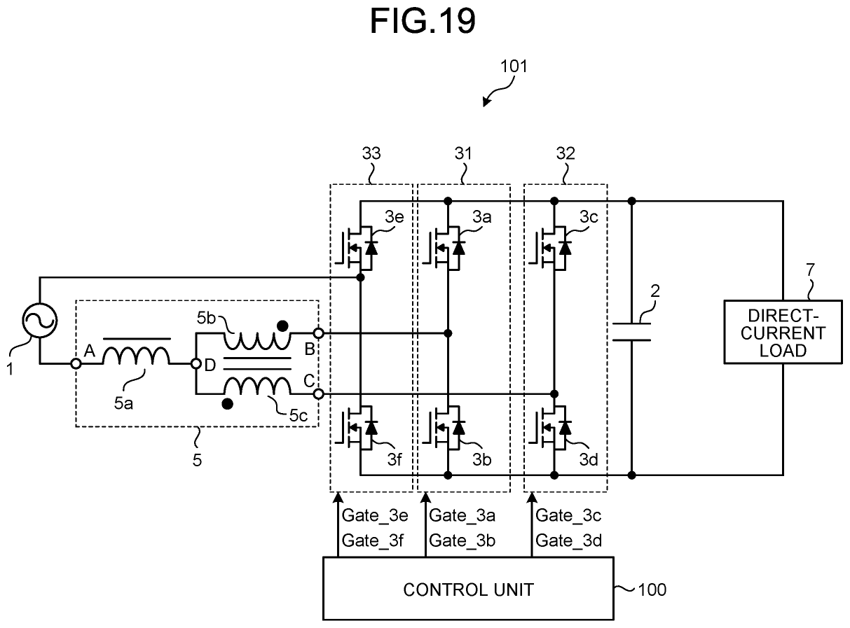

FIG. 18 illustrates a second modification to the power converting apparatus 101 according to the first embodiment. The power converting apparatus 101 illustrated in FIG. 18 is the power converting apparatus 101 illustrated in FIG. 1 and the like with the alternating-current power supply 1 connected thereto such that the polarity of the alternating-current power supply 1 is opposite to that of FIG. 1 and the like. The control unit 100 configured as illustrated in the FIG. 18 can also perform simple switching control for controlling the switching elements as in the power converting apparatus 101 illustrated in FIG. 1 and the like. FIG. 19 illustrates a third modification to the power converting apparatus 101 according to the first embodiment. The power converting apparatus 101 illustrated in FIG. 19 is the power converting apparatus 101 illustrated in FIG. 18 with the rectifier circuit 41 replaced with the switching circuit 33. As in the power converting apparatus 101 illustrated in FIG. 17, the control unit 100 configured as illustrated in the FIG. 19 can perform the synchronous rectification that switches on the switching element 3e or 3f in accordance with the voltage polarity or the current polarity of the alternating-current power supply 1.

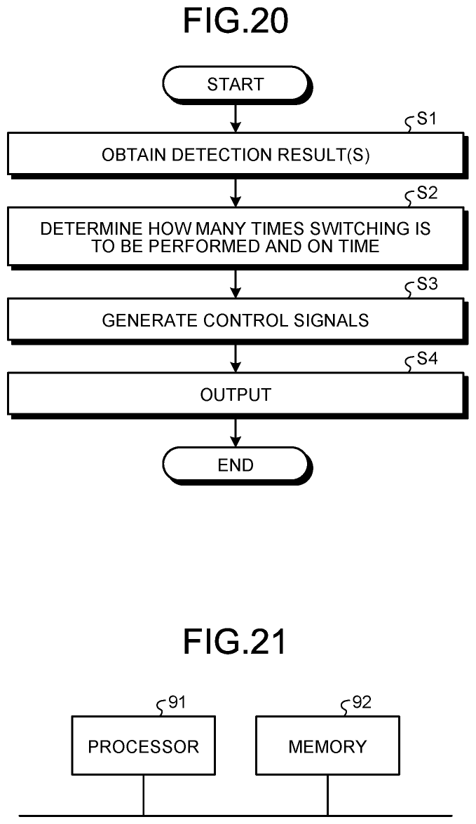

With reference to a flowchart, a description is provided of how the control unit 100 of the power converting apparatus 101 operates. FIG. 20 is the flowchart that illustrates the operation of performing the simple switching control by the control unit 100 of the power converting apparatus 101 according to the first embodiment. The control unit 100 of the power converting apparatus 101 obtains a detection result or detection results from, for example, the alternating-current voltage and alternating current detection unit 10, the direct-current voltage detection unit 11, the alternating-current voltage detection unit 12, or the direct-current voltage and direct current detection unit 13 (step S1). On the basis of at least one of the obtained detection results, the control unit 100 determines the number of times the switching is to be performed and the ON time for each of the switching elements 3a to 3d of the switching circuits 31 and 32 (step S2). The control unit 100 generates the control signals Gate_3a to Gate_3d that control the switching elements 3a to 3d such that the switching elements 3a to 3d are switched on and off (step S3) and outputs the control signals Gate_3a to Gate_3d to the switching circuits 31 and 32 (step S4).

A description is provided next of a hardware configuration of the control unit 100 in the power converting apparatus 101. FIG. 21 illustrates an example of the hardware configuration that implements the control unit 100 of the power converting apparatus 101 according to the first embodiment. The control unit 100 is implemented with use of a processor 91 and a memory 92.

The processor 91 is a central processing unit (CPU) (also referred to as a processing unit, an arithmetic unit, a microprocessor, a microcomputer, a processor, or a digital signal processor (DSP)) or a system large-scale integration (LSI). The memory 92 is, for example, a nonvolatile or volatile semiconductor memory such as a random-access memory (RAM), a read-only memory (ROM), a flash memory, an erasable programmable read-only memory (EPROM), or an electrically erasable programmable read-only memory (EEPROM) (registered trademark). The memory 92 is not limited to these and may be a magnetic disk, an optical disk, a compact disk, a mini disk, or a digital versatile disc (DVD).

As described above, the control unit 100 of the power converting apparatus 101 according to the present embodiment controls the switching circuits 31 and 32, that is to say, determines the number of times the switching is to be performed and the ON time for each of the switching circuits 31 and 32 in performing, at least once in the half period of the alternating-current power supply 1, the simple switching control that allows the two switching circuits 31 and 32 to short-circuit the coupling reactor 5 to the alternating-current power supply 1. As a result, the power converting apparatus 101 can significantly reduce switching losses caused upon switching of the switching elements 3a to 3d on and off, and losses such as high-frequency copper and iron losses caused when the coupling reactor 5 is excited at a higher frequency. The power converting apparatus 101 can thus achieve highly efficient power conversion.

### Second Embodiment

The power converting apparatus 101 according to the first embodiment has the rectifier circuit 41 disposed at a stage following the switching circuits 31 and 32. A second embodiment is described as to the power converting apparatus 101 with the rectifier circuit 41 omitted and a full-wave rectifier circuit disposed at a stage following the alternating-current power supply 1.

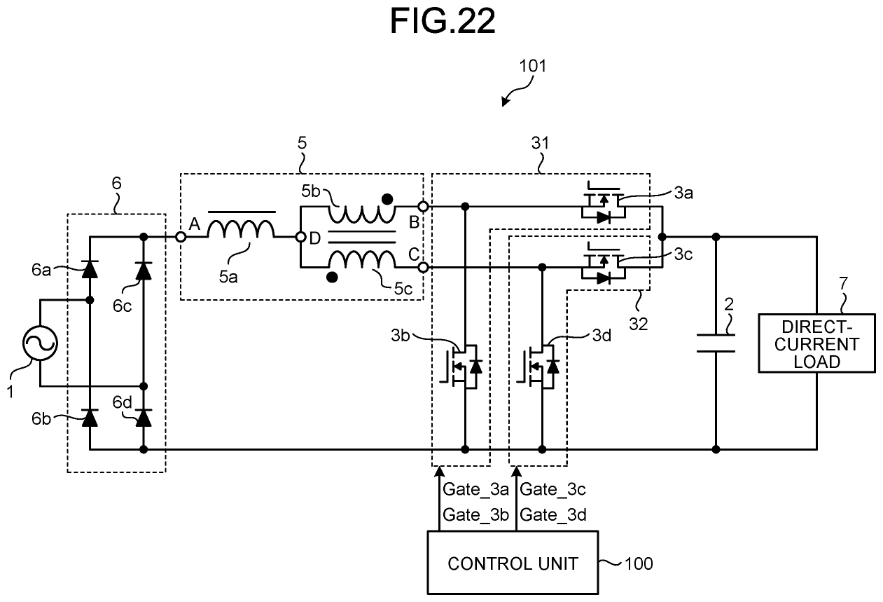

FIG. 22 illustrates a first example configuration of the power converting apparatus 101 according to the second embodiment. The power converting apparatus 101 is the power converting apparatus 101 according to the first embodiment illustrated in FIG. 1, with the rectifier circuit 41 omitted and the full-wave rectifier circuit 6 added. The full-wave rectifier circuit 6 includes rectifying elements 6a to 6d. The power converting apparatus 101 according to the second embodiment has the full-wave rectifier circuit 6 disposed at a stage following the alternating-current power supply 1, and the coupling reactor 5 and the two switching circuits 31 and 32 connected to an output side of the full-wave rectifier circuit 6. For the control unit 100 of the power converting apparatus 101 according to the second embodiment, a simple switching control scheme and current paths under each simple switching control are the same as those in the power converting apparatus 101 according to the first embodiment when half-waves are positive. The detailed descriptions thereof are therefore omitted.

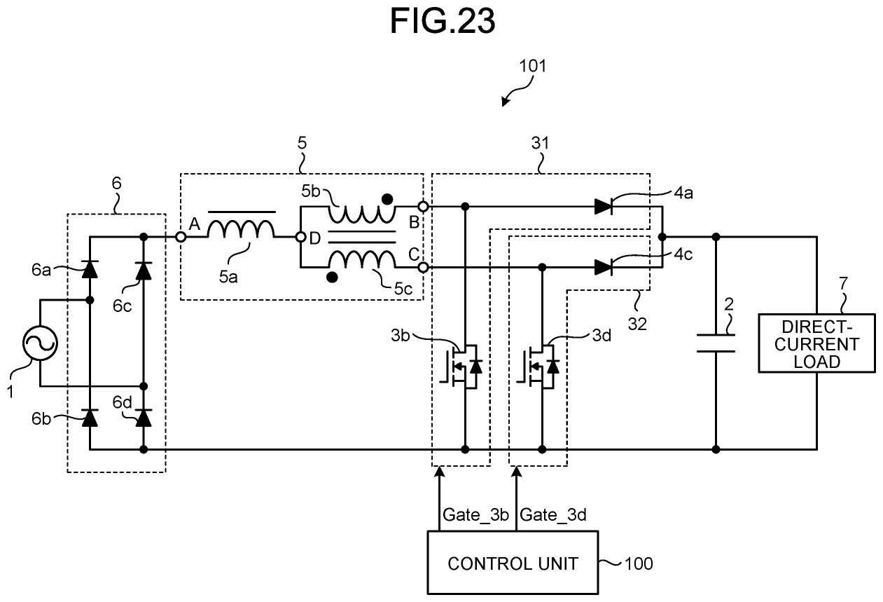

In the power converting apparatus 101 according to the second embodiment, a current flows through the switching elements 3a and 3c only in such a direction as to change the smoothing capacitor 2. For this reason, at least one of the switching elements 3a and 3c is replaceable with a rectifying element, as illustrated in FIG. 23. FIG. 23 illustrates a second example configuration of the power converting apparatus 101 according to the second embodiment. In the example of FIG. 23, the power converting apparatus 101 has the rectifying element 4a in place of the switching element 3a and a rectifying element 4c in place of the switching element 3c.

The power converting apparatuses 101 of FIGS. 22 and 23 according to the second embodiment can both obtain the same effects as that of the first embodiment.

### Third Embodiment

A description is provided of a refrigeration cycle apparatus according to the third embodiment that includes the power converting apparatus 101. Examples of the refrigeration cycle apparatus include an air conditioner and a refrigeration apparatus, among others. In the third embodiment, the description is of a specific example in which the power converting apparatus 101 is installed in an air conditioner.

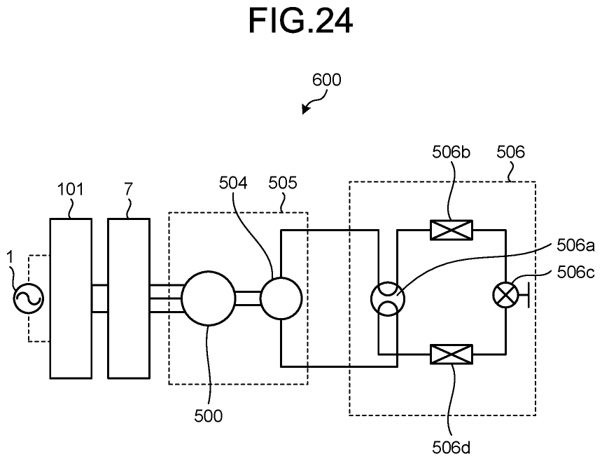

FIG. 24 illustrates a configuration example of the refrigeration cycle apparatus 600 according to the third embodiment. The refrigeration cycle apparatus 600 is the air conditioner that includes the power converting apparatus 101 according to the first or second embodiment. An inverter is connected as the direct-current load 7 to an output side of the power converting apparatus 101, and a motor 500 is connected to an output side of the inverter, which is the direct-current load 7. A compressor 505 includes the motor 500 and a compression element 504. The motor 500 that is connected to the inverter, which is the direct-current load 7, is connected to the compression element 504. A refrigeration cycle unit 506 is configured to include a four-way valve 506a, an indoor heat exchanger 506b, an expansion valve 506c, and an outdoor heat exchanger 506d.

A path of a refrigerant that circulates in the refrigeration cycle apparatus 600 is such that the refrigerant leaves the compression element 504, flows through the four-way valve 506a, the indoor heat exchanger 506b, the expansion valve 506c, and the outdoor heat exchanger 506d, flows through the four-way valve 506a again, and returns to the compression element 504. The power converting apparatus 101 converts alternating-current power from the alternating-current power supply 1 into direct-current power and outputs the direct-current power to the inverter, which is the direct-current load 7. In the refrigeration cycle apparatus 600, the inverter, which is the direct-current load 7, rotates the motor 500. With the rotation of the motor 500, the compression element 504 compresses the refrigerant, enabling the refrigerant to circulate in the refrigeration cycle unit 506.

By including the power converting apparatus 101 according to the first or second embodiment, the refrigeration cycle apparatus 600 is enabled to enjoy the effects described in the first embodiment. The application of the power converting apparatus 101 is not limited to the refrigeration cycle apparatus 600. The power converting apparatus 101 may be installed for a driving purpose in a blower or another.

The above configurations illustrated in the embodiments are illustrative of contents of the present invention, can be combined with other techniques that are publicly known, and can be partly omitted or changed without departing from the gist of the present invention.

1. A power converting apparatus for converting an alternating-current power supplied from an alternating-current power supply into a direct-current power and outputs the direct-current power to a direct-current load, the power converting apparatus comprising:
two or more switching circuits connected in parallel with the direct-current load;
a coupling reactor including three or more connection terminals, two of the at least three connection terminals being each connected to an alternating-current terminal of a corresponding one of two switching circuits among the two or more switching circuits, the coupling reactor having a magnetic flux induced in a direction corresponding to operations of the two switching circuits; and
a control unit performing, at least once in a half period of the alternating-current power supply, a simple switching control allowing the two switching circuits to short-circuit the coupling reactor to the alternating-current power supply.

2. The power converting apparatus according to claim 1, wherein
the control unit determines the number of times the two switching circuits perform switching and ON times of the two switching circuits and assigns the determined number of times and the determined ON times to the two switching circuits in performing the simple switching control.

3. The power converting apparatus according to claim 2, comprising:
an alternating-current voltage detection unit detecting an alternating-current voltage of the alternating-current power supplied from the alternating-current power supply to the power converting apparatus; and
a direct-current voltage detection unit detecting a direct-current voltage of the direct-current power output from the power converting apparatus to the direct-current load, wherein
the control unit controls the two switching circuits on a basis of a detection result from the alternating-current voltage detection unit and a detection result from the direct-current voltage detection unit.

4. The power converting apparatus according to claim 3, wherein
the control unit switches a switching circuit operating in a half period of the alternating-current power supplied from the alternating-current power supply on a basis of a detection result from the alternating-current voltage detection unit and a detection result from the direct-current voltage detection unit.

5. The power converting apparatus according to claim 3, wherein
when a value twice an absolute value of the alternating-current voltage detected by the alternating-current voltage detection unit is greater than the direct-current voltage detected by the direct-current voltage detection unit, the control unit allows one or both of the two switching circuits to short-circuit the coupling reactor to the alternating-current power supply and increases an absolute value of an alternating current of the alternating-current power.

6. The power converting apparatus according to claim 3, wherein
when a value twice an absolute value of the alternating-current voltage detected by the alternating-current voltage detection unit is greater than the direct-current voltage detected by the direct-current voltage detection unit, the control unit stops both of the two switching circuits and decreases an absolute value of an alternating current of the alternating-current power.

7. The power converting apparatus according to claim 3, wherein
when a value twice an absolute value of the alternating-current voltage detected by the alternating-current voltage detection unit is smaller than the direct-current voltage detected by the direct-current voltage detection unit, the control unit allows both of the two switching circuits to short-circuit the coupling reactor to the alternating-current power supply and increases an absolute value of an alternating current of the alternating-current power.

8. The power converting apparatus according to claim 3, wherein
when a value twice an absolute value of the alternating-current voltage detected by the alternating-current voltage detection unit is smaller than the direct-current voltage detected by the direct-current voltage detection unit, the control unit stops one or both of the two switching circuits and decreases an absolute value of an alternating current of the alternating-current power.

9. The power converting apparatus according to claim 2, wherein
each of the switching circuits includes two or more switching elements, and
in the simple switching control, the control unit switches on or off at least one switching element of one of the two switching circuits or switches on or off at least one switching element of each of the two switching circuits.

10. The power converting apparatus according to claim 1, wherein
each of the switching circuits includes two or more switching elements, and
the two or more switching includes a switching element not short-circuiting the coupling reactor to the alternating-current power supply, during which period of time the control unit performs synchronous rectification switching on the switching element not short-circuiting the coupling reactor to the alternating-current power supply.

11. The power converting apparatus according to claim 1, comprising
a switching circuit connected in parallel with the direct-current load, the switching circuit including two or more switching elements and an alternating-current terminal connected to the alternating-current power supply, wherein
the control unit performs synchronous rectification that switches on at least one of the at least two switching elements on a basis of polarity of an alternating-current voltage or an alternating current of the alternating-current power supplied from the alternating-current power supply.

12. The power converting apparatus according to claim 1, wherein the coupling reactor includes
a first wound part having a first winding thereon, the first winding being connected to one of the two connection terminals and
a second wound part having a second winding thereon, the second winding being connected to the other of the two connection terminals, the first winding and the second winding being AC-coupled to each other.

13. The power converting apparatus according to claim 2, comprising
an alternating-current voltage detection unit detecting an alternating-current voltage of the alternating-current power supplied from the alternating-current power supply to the power converting apparatus, wherein
the control unit determines the number of times each of the switching circuits performs switching and an ON time of each of the switching circuits on a basis of a detection result from the alternating-current voltage detection unit.

14. The power converting apparatus according to claim 2, comprising
a direct-current voltage and direct current detection unit detecting a direct-current voltage and a direct current of the direct-current power output from the power converting apparatus to the direct-current load, wherein
the control unit determines the number of times each of the switching circuits performs switching and an ON time of each of the switching circuits on a basis of detection results from the direct-current voltage and direct current detection unit.

15. The power converting apparatus according to claim 2, wherein
when the direct-current load is an inverter connected to a motor,
the control unit determines the number of times each of the switching circuits performs switching and an ON time of each of the switching circuits on a basis of at least one of an output frequency, output torque, an output voltage, or an output current of the inverter.

16. A refrigeration cycle apparatus comprising the power converting apparatus according to claim 1.
